(19) United States
(12) Patent Application Publication
(10) Pub. No.: US 2015/0296980 A1
(43) Pub. Date: Oct. 22, 2015

(54) WOOD END GRAIN SLAB AND METHOD

(71) Applicant: Morrison Brothers Company, Dubuque, IA (US)

(72) Inventor: Charles D. Glab, Dubuque, IA (US)

(21) Appl. No.: 14/329,925

(22) Filed: Jul. 12, 2014

Related U.S. Application Data
(60) Provisional application No. 61/981,707, filed on Apr. 18, 2014.

(51) Int. Cl. A47B 77/02; A47B 96/18; B32B 38/00

(52) U.S. Cl. CPC A47B 77/022; B32B 38/0004; A47B 77/02; A47B 96/18

(57) ABSTRACT

A wood end grain slab comprises a plurality of wooden blocks of varying length adhered side-by-side with adjacent pairs of the blocks having an upper surface with mirrored end grain patterns. The slab may be formed by ripping a board lengthwise into a plurality of ordered parallel cut strips having lengthwise edges, gluing the parallel cut strips, in order, together along the lengthwise edges to form a glued board, ripping the glued board at an angle oblique to the lengthwise edges to form oblique cut strips, forming blocks having sides exposing end grain from the oblique cut strips, rotating adjacent blocks to mirror the end grain of the adjacent blocks and gluing the blocks.

### CROSS REFERENCE TO RELATED APPLICATION

The present application claims priority under 35 USC Section 120 from co-pending US Provisional Application Serial No. 61/981,707 filed on Apr. 18, 2014 by Charles D. Glab and entitled WOOD END GRAIN SLAB AND METHOD, full disclosure of which is hereby incorporated by reference.

### BACKGROUND

Wood end grain slabs are frequently utilized to form wooden countertops and wooden cutting boards or chopping blocks. If not sufficiently thick, such wood end grain slabs often warp and crack when exposed to sudden changes between dry and wet atmospheric conditions. Although penetrating sealants may mitigate the warping issue, in many instances, such sealants are unacceptable for food contact with a cutting surface.

### BRIEF DESCRIPTION OF THE DRAWINGS

FIG. 1 is a perspective view of an example counter having a top comprising an example wood end grain slab.

FIG. 2 is a perspective view of the wood end grain slab of FIG. 1.

FIG. 3 is top view of a portion of the wood end grain slab of FIG. 2 schematically illustrating an example layout of blocks.

FIG. 4 is a flow diagram of an example method for forming the wood end grain slab of FIG. 2.

FIG. 5 is an end isometric view of a board for forming the wood end grain slab of FIG. 2 according to the method of FIG. 4.

FIG. 6 is an end view of parallel cut strips formed by severing the board of FIG. 5.

FIG. 7 is a top view of the strips of FIG. 6.

FIG. 8 is a top view of the strips of FIG. 6 glued to form a glued board.

FIG. 9 is a top view of the board of FIG. 8 illustrating oblique angle cut lines at which the board is to be ripped.

FIG. 10A is a top view of oblique cut strips formed by cutting the board of Figure line along the illustrated oblique angle cut lines.

FIG. 10B illustrates the oblique cut strips and the gluing of shorter oblique cut strips to form longer strips.

FIG. 11 is a top view of oblique cut strips of FIG. 10 glued to one another along the oblique angle cut lines to form an oblique glued board.

FIG. 12 is a top view of the oblique glued board illustrating cross cut lines in which the board is to be crosscut.

FIG. 13 is a top view of cross cut strips formed by crosscutting the oblique glued board of FIG. 12.

FIG. 14 is a side view of two pairs of the cross cut strips of FIG. 13.

FIG. 15 is a side view of the cross cut strips of FIG. 14 after pairs of adjacent blocks have been rotated in the directions indicated by the arrows of FIG. 14 to book match the pairs of adjacent strips.

FIG. 16 is a side view of the strips of FIG. 15 glued to one another to form a wood end grain slab row.

FIG. 17 is a perspective view of a plurality of rows glued to one another to form a wood end grain slab.

FIG. 18 is an end isometric view of a board for forming the wood end grain slab according to a variation of the method of FIG. 4.

FIG. 19 is an end view of parallel cut strips formed by severing the board of FIG. 18.

FIG. 20 is a top view of the strips of FIG. 19.

FIG. 21 is a top view of the strips of FIG. 19 glued to form a glued board.

FIG. 22 is a top view of the board of FIG. 21 illustrating oblique angle cut lines at which the board is to be ripped.

FIG. 23 is a top view of oblique cut strips formed by cutting the board of Figure line along the illustrated oblique angle cut lines.

FIG. 24 is a top view of oblique cut strips of FIG. 23 severed into segments.

FIG. 24 illustrates the oblique cut strips and the gluing of shorter oblique cut strips to form longer strips.

FIG. 25 is an end view of the segments of FIG. 24.

FIG. 26 is a side view of segments of FIG. 25 glued to one another to form a plank.

FIG. 27 is a perspective view of the plank of FIG. 26.

FIGS. 28-30 are top views of the plank of FIG. 27 being severed lengthwise to form strips.

FIG. 31 is a top view of two pairs of the separated strips

FIG. 32 is an end view of the strips of FIG. 31.

FIG. 33 is a top view of the strips of FIG. 32 after the blocks have been rotated in the directions indicated by the arrows of FIG. 32 to book match adjacent pairs of the strips.

FIG. 34 is a top view of the blocks of FIG. 33 glued to one another to form a slab.

FIG. 35 is a side view of the slab of FIG. 34.

FIG. 36 is a side view of the planed slab of FIG. 35.

FIG. 37 is a top view of the slab of FIG. 36 alongside another slab similar to the slab of FIG. 36.

FIG. 38 is a top view of an example larger slab form by gluing the individual slabs of FIG. 27 together.

### DETAILED DESCRIPTION OF THE EXAMPLE EMBODIMENTS

FIG. 1 is a perspective view of an example kitchen island or counter 20 comprising a base 22 and a top 24. Top 24 comprises a wood end grain slab 26 dimensioned for use as top 20. Although illustrated as continuous, top 24 may include cutouts for the reception of sinks and the like. As will be described hereafter, the construction of wood end grain slab 26 forming top 24 is less susceptible to cracking and

warping when experiencing sudden changes in atmospheric conditions such as sudden changes between dry and wet environments. As a result, wood end grain slab 26 and top 24 may be provided with a reduced thickness, reducing the cost of top 24.

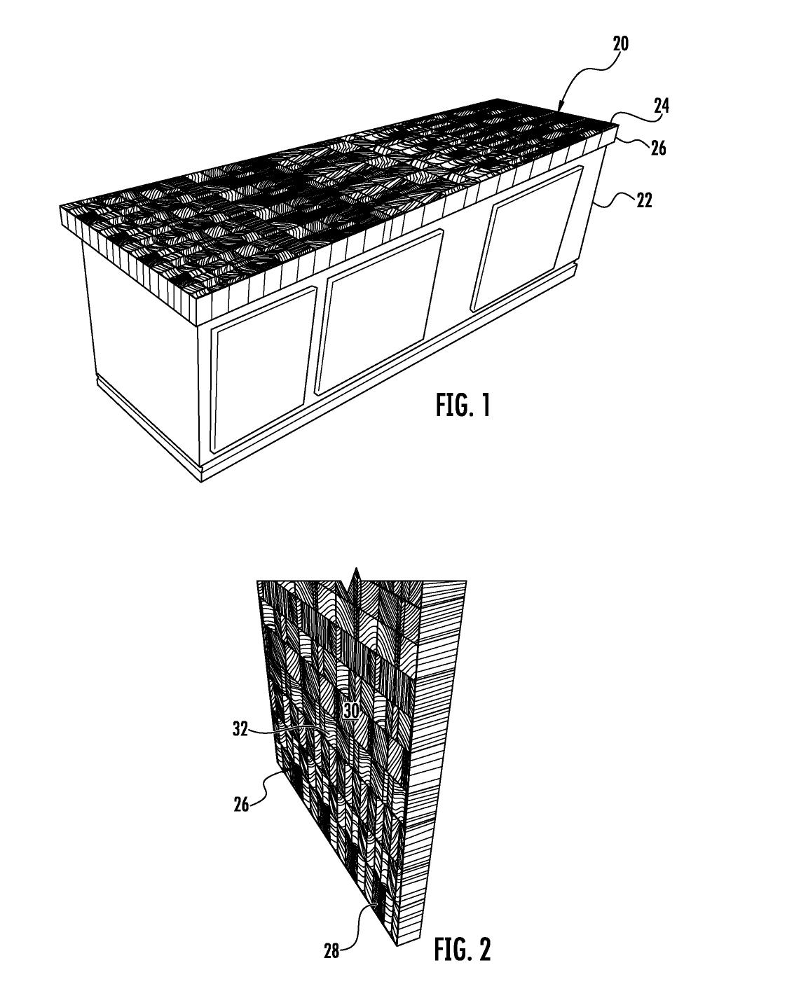

FIG. 2 is a perspective view of wood end grain slab 26 prior to being secured to base 22 and prior to being treated with food-grade non-sealing type surface coatings. Examples of food grade coatings include mineral oil and bees wax or surface coatings. Wood end grain slab 26 is constructed from a plurality of wooden blocks 28 of varying length adhered side-by-side with adjacent pairs of the blocks 28 having an upper surface 30 with end grain patterns 32 that mirror one another. For purposes of this disclosure, the term “end grain” refers to the grain that is exposed when a piece of wood is cut perpendicular to the grain. Wood end grain slab 26 has a thickness of less than 2.5 inches. In the example illustrated in which wood end grain slab 26 is to form a counter top such as top 24, wood end grain slab 26 has a surface area of at least 9 ft.². The construction of wood end grain slab 26 allows wood end grain slab 26 to have a surface area sufficiently large for a countertop while, at the same time, having a reduced thickness with a reduced corresponding risk of warping or cracking due to sudden changes in atmospheric conditions.

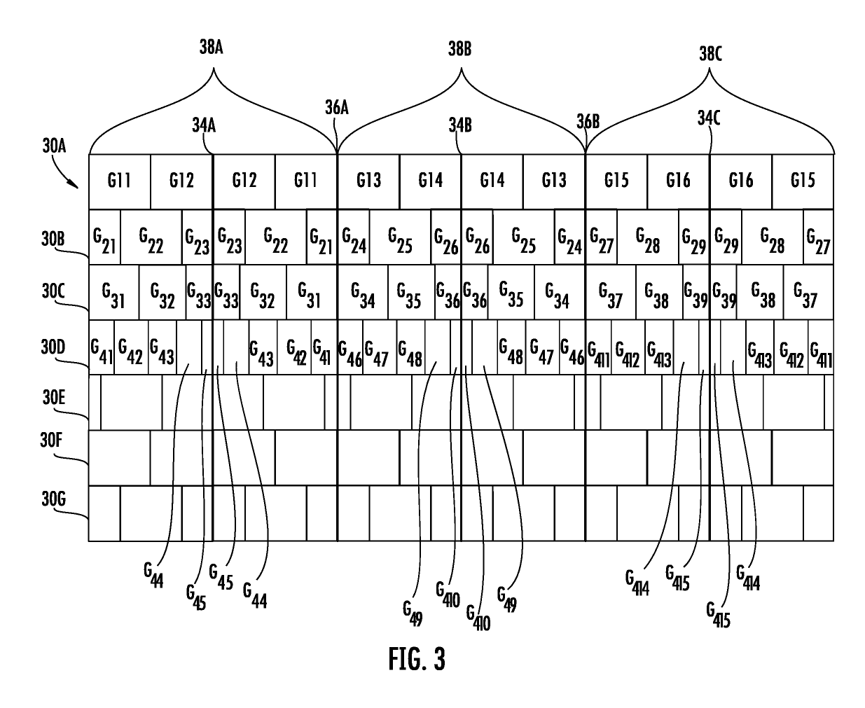

FIG. 3 is an enlarged top view of a portion of wood end grain slab 26. As shown by FIG. 3, slab 26 comprises a plurality of rows 30A, 30B, 30C, 30D, 30E, 30F, 30G (collectively referred to as rows 30) of blocks 28 which are adhered or glued to one another. Individual blocks 28 in each of rows 30 are glued to one another along either series spine glue seams 34A, 34B, 34C (collectively referred to as series spine glue seams 34), series end glue seams 36A, 36B (collectively referred to as series end glue seams 36) or offset glue seams 38. Each row 30 of blocks 28 comprises two or more series 38 of blocks, wherein each series 38 begins and ends along two opposing series end glue seams 36 and wherein each series 38 comprises the same number of blocks 28 on each side of the associated series spine glue seam 34. In the example illustrated, slab 26 is illustrated as comprising three series of blocks 28, series 32A, 32B and 32C. Each of series 38 of blocks 28 comprises a first subset of blocks 28 on a first side of the series spine glue seam and a second subset of an equal number of blocks on a second side of the associated series spine glue seams 34. The blocks of the first subset and the second subset of each series are identical in both size and grain pattern, wherein the blocks 28 of each of the subsets mirror one another. In the example illustrated, the end grain of each of blocks 28 faces upwardly or downwardly along the main or major surface of slab 28 and is indicated by a designator Gxy, with x indicating the row and with y indicating the end grain pattern.

In the example illustrated, series 38A in row 30A of slab 26 comprises a first subset of two blocks 28 on a first side of series spine glue seam 34A and a second subset of two blocks 28 on a second opposite side of series spine glue seem 34A. The first subset and the second subset of series 38A each comprises blocks 28 having characteristics G11 and G12. Blocks indicated having the same characteristics are identical in size and end grain. Blocks 28 with characteristic G11 in the first subset and the second subset of series 38A are identical to one another in size and in end grain except that such blocks with characteristic G11 mirror one another about spine glue seam 34A. For example, if block 28 with characteristic G11 in the first subset has an end grain pattern that is generally concave towards spine glue seam 34A, block 28 with the same characteristic G11 in the second subset would have an identical end grain pattern that is also generally concave towards spine glue seam 34A. Likewise blocks 28 with characteristic G12 in the first subset and the second subset of series 38A are identical to one another in size and in end grain except that such blocks 28 with characteristic G12 also mirror one another about spine glue seam 34A. As shown by FIG. 3, the arrangement of blocks 28 in each first subset of each series also mirrors the arrangement of blocks 28 in each second subset of each series along the associated spine glue seam 34. For example, series 38A in row 30B comprises a first subset three distinct blocks 28 with the order of characteristics G21, G22 and G23 and a second subset of blocks 28 with the mirroring order of characteristics G23, G22 and G21. In the example illustrated, each of rows 30 comprises differently configured series 38 between series and glue seams 36. In other words, each series 38 comprises blocks 28 with different characteristics as compared to blocks 28 in the series in any adjacent rows 30. For example, series 38A in row 30B comprises blocks 28 having different characteristics as compared to the blocks 28 of series 38A in the adjacent rows 30A and 30B.

As further shown by FIG. 3, the construction of slab 26 provides multiple offset glue seams 38 which are not aligned with glue seams of adjacent rows 30. At the same time, the subsets of each series 38 mirror one another about series spine glue lines 34. The offsetting of glue lines 38 facilitated by the continuous variation of block lengths amongst the different series in each row and amongst adjacent rows in combination with the mirroring of end grains 38 in each series reduces shrinkage, cracking and warping of slab 28 when exposed to sudden changes between dry and wet atmospheric conditions. As a result, as compared to existing wood end grain slabs which typically require a much greater thickness to inhibit such shrinkage, cracking and warping, slab 26 may be provided with a reduced thickness, less than 2.5 inches, without experiencing the same degree of shrinkage, cracking warping that otherwise might occur with existing wood end grain slabs of the same thickness.

Although FIG. 3 illustrates an example slab 26 having seven rows 30 with each row 30 being formed by three complete series 38 of blocks 28, in other implementations, slab 26 may have a greater or fewer number of such rows and may include a greater or fewer number of series 38. In some implementations, end of portions of slab 26 may have incomplete series or subsets of blocks 28. Although each of series 38 of blocks 28 are illustrated as having the depicted number of blocks 28 having the depicted sizes in both dimensions (left to right and vertical as seen in FIG. 3), in other implementations, the number of blocks 28 as well as the relative size of blocks 28 in each of series 38 and in each of rows 30 may vary.

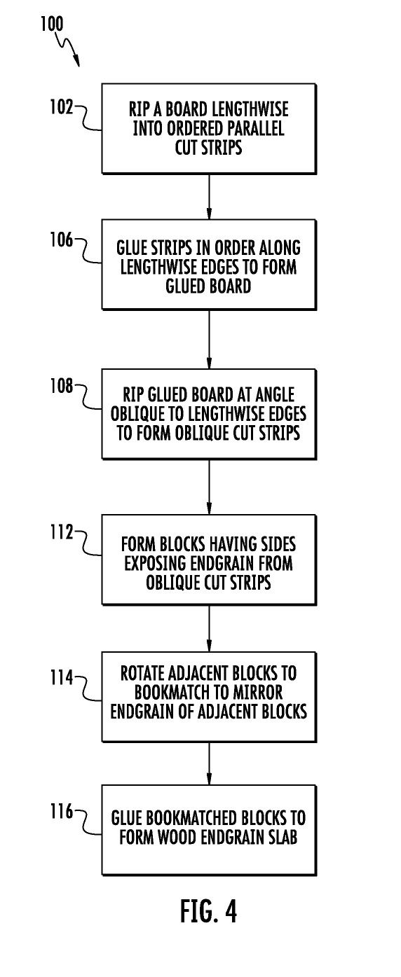

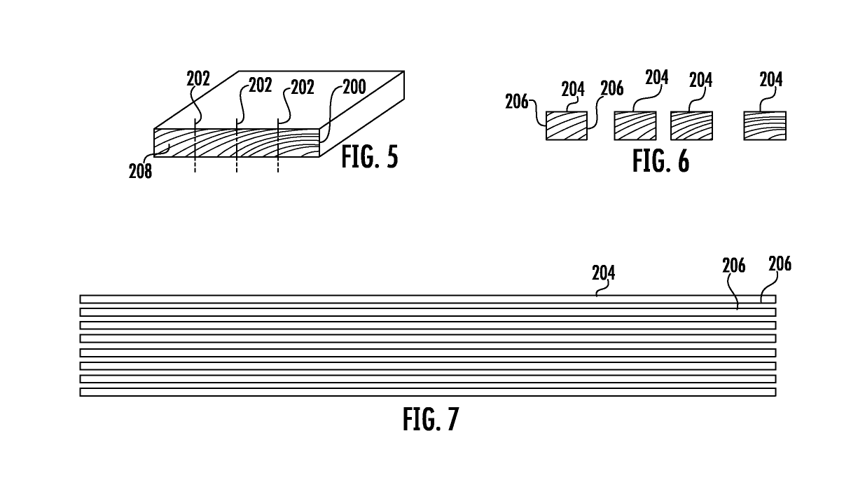

FIG. 4 is a flow diagram of an example method 100 for forming slab 26 (shown in FIG. 3). FIGS. 5-16 illustrate the forming of slab 26 according to method 100. As indicated by step 102 and FIG. 4 and illustrated in FIGS. 5 and 6, method 100 starts by ripping a board 200 along cut lines 202 extending parallel to the longitudinal lengthwise edges of board 200 so as to form a plurality of ordered parallel cut strips 204 having lengthwise edges 206. As shown by 5 and 6, board 200 and each of strips 204 has an end grain 208.

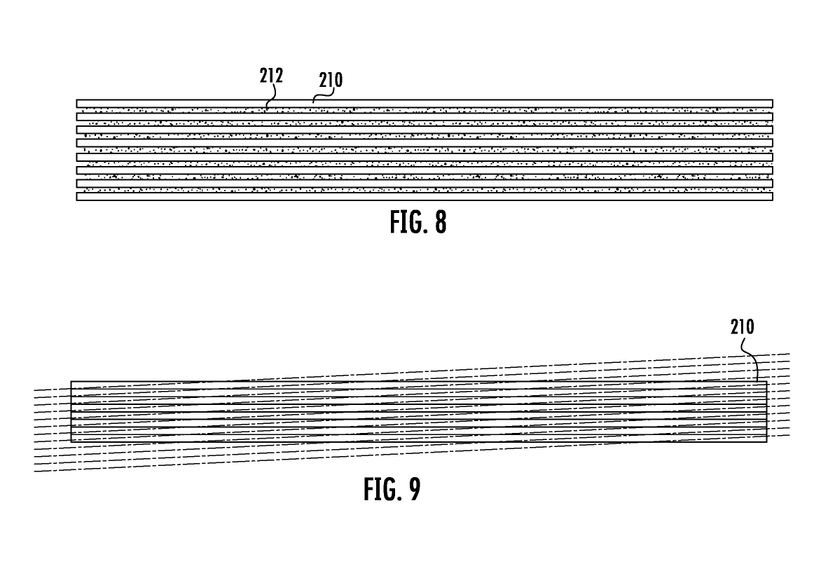

As indicated by step 106 and illustrated by FIGS. 7 and 8, the parallel cut strips 204 are glued together along lengthwise edges 206, wherein glue is placed along surfaces of edges 206, to form glued board 210 (shown completed in FIG. 8). In one implementation, the strips are glued together in order (in the same order as original uncut board 200 prior to being cut into strips 204). In another implementation, the strips are rearranged or randomly ordered prior to being glued to one another. Board 210 is similar to board 200 except that board 210 comprises a series of parallel glue lines 212 extending parallel to the original longitudinal are lengthwise side edges of 200.

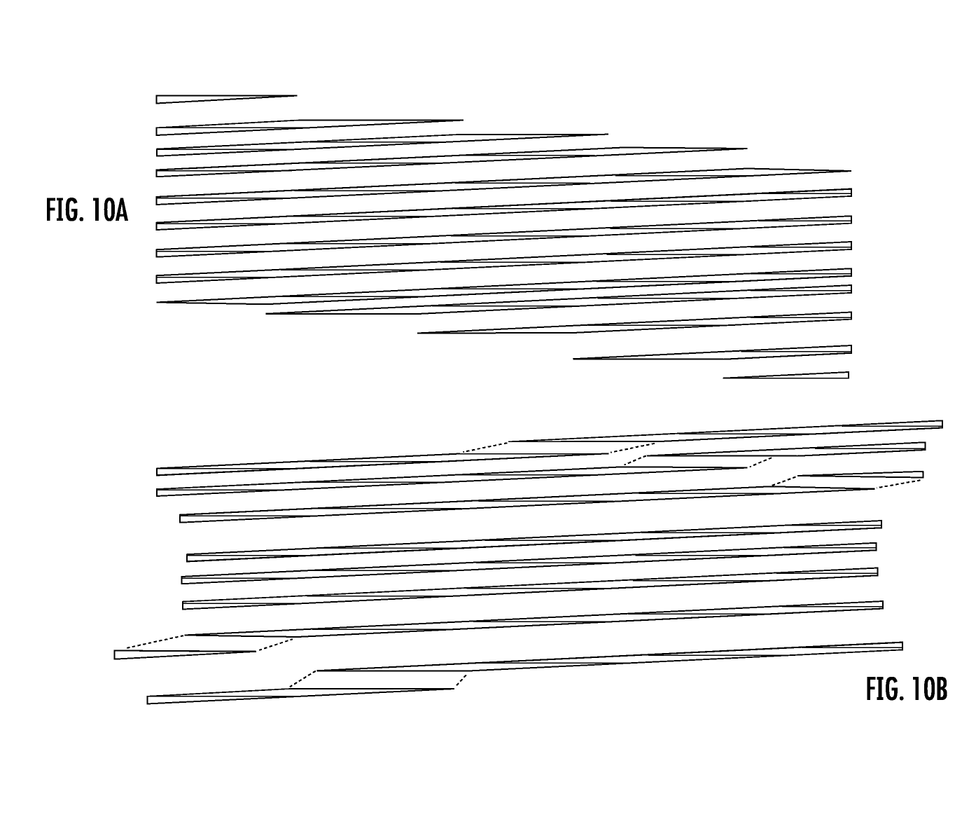

As indicated by step 108 and illustrated by FIGS. 9 and 10, method 100 comprises ripping the glued board 210 (shown in FIG. 8) at an angle oblique to the lengthwise edges 206 of the strips 204 to form oblique cut strips 216. In one implementation, the oblique angle at which glued board 210 is cut is less than or equal to 5 degrees. In one implementation, each of the oblique cut strips 216 have a width of less than 2.5 inches. As noted above with respect to the completed slab 126, the construction of the finished slab 26 allows slab 26 to have a reduced thickness without the normally associated problems of cracking, shrinkage and warping. Cutting strips 216 with a width of less than 2.5 inches ultimately facilitates the formation of slab 26 with a thickness of less than 2.5 inches. As illustrated by 10B, in some implementations, shorter oblique cut strips 216 are glued to one another to form longer composite strips 216.

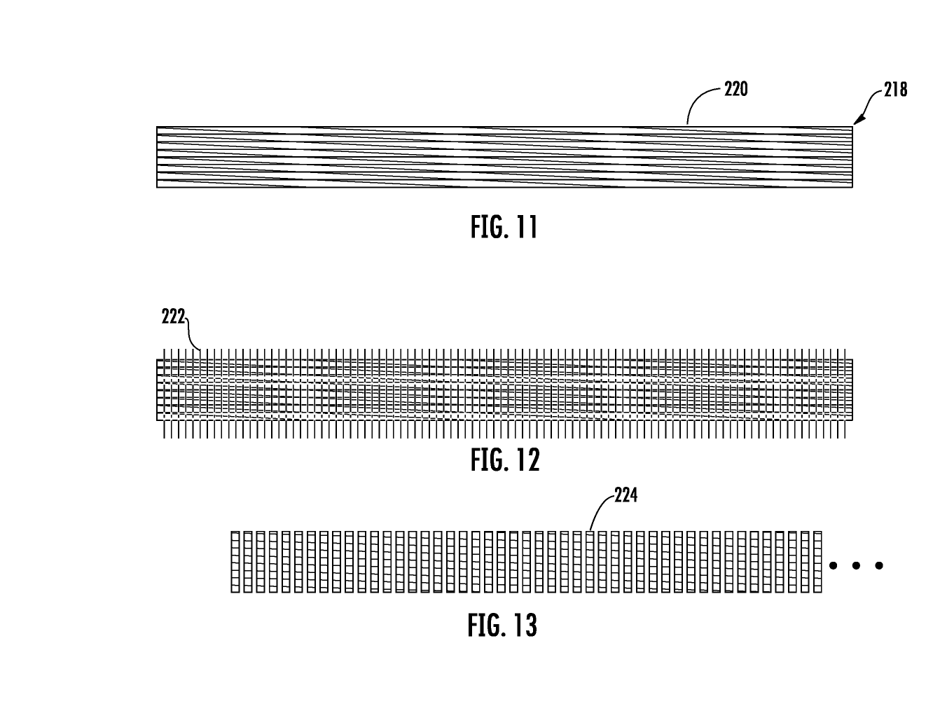

As indicated by step 112 (shown in FIG. 4), the oblique cut strips 216 formed in step 108 are formed into blocks 228 having sides exposing end grain. FIGS. 11-13 illustrate one example series of steps for forming the oblique cut strips 216 into blocks having ends exposing end grain. As shown by FIG. 11, the oblique cut strips 216 are glued together along the oblique side edges of strips 216 to form oblique glued board 218 having oblique glue lines 220. In one implementation, the glue is applied to the oblique side surfaces or side edges of strips 216 (extending horizontal) an angle glue lines (corresponding to the gluing of strips shown in FIG. 8). Although FIG. 11 illustrates the oblique cut strips 216 as being glued back together in order, in other implementations, the oblique cut strips 216 are resorted and glue to one another out of order with one another with the joints not necessarily on an angle. In such an implementation, the variations from the tapers are already built into them such that the cross cut, book match facilities the layout of the example slab 26 shown in FIG. 3. As shown by FIGS. 12 and 13, the oblique glued board 218 is cross cut along cut lines 222 to form cross cut strips 224 having sides 226 that expose end grain.

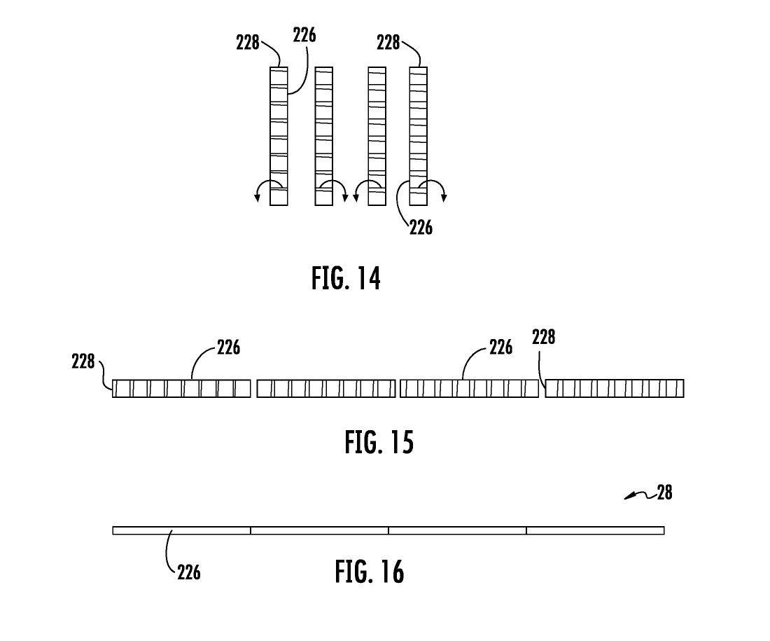

As indicated by step 114 in FIG. 4 and illustrated in FIGS. 14 and 15, adjacent pairs of blocks 228 are rotated to book match such pairs of blocks 228 such sides 226 face either an upper down direction and such that the end grain previously expose along the sides 226 of the blocks 28 mirror one another, wherein the end grain of one block of a pair mirrors the end grain of the associated other block of the pair. In one implementation, such book match rotation involves rotating one block 228 of the pair clockwise and the other block 228 of the pair counterclockwise, either away from one another or towards one another.

As indicated by step 116 in FIG. 4 and illustrated in FIGS. 16 and 17, the book matched blocks 332 shown in FIG. 15 are kept in order and glued to one another along faces 228 to form the wood end grain slab 26 shown in FIG. 3. In the example illustrated, blocks 228 are glued into and as shown in FIG. 16 to form a single row of slab 26. As shown by FIG. 17, multiple rows are glued side to side to form an example slab 26. In one implementation, the formed wood end grain slab 26 is further planed to a predetermined uniform thickness across its dimension. In one implementation, slap 26 is glued to one or more other slabs 26 to form top 24 for counter 20 (shown in FIG. 1) or for other uses.

According to one example, 5/4 select lumbers ripped to 1 ⅝ n widths leading pieces 1 inch thick (roughly) ×1 ⅝ inches wide and 12 foot long. The rib sticks are glued together to form boards 1 inch thick ×13 inches wide by 12 foot long. The glued boards are ripped near the centerline a slight angle (less than 5°) then remaining halves are ripped parallel to the slight angle in 1 ⅝ inch increments reading sticks 1 inch thick ×1 ⅝ inches wide ×variable lengths. The rib sticks are glued together to form boards 1 inch thick ×13 inches wide by 12 foot long. The ripped boards are then cross cut in 1 ⅝ inch increments leaving sticks 1 inch ×1 ⅝ inches wide ×13 inches long and In the original order in sequence. The sticks are then rotated impairs towards each other and up as if opening a book. The result is the exposure of end grain, book matched pairs, in sequence. The pairs of stacked with 1/5/8 inch dimension that vertical glued together to a 12 foot length sequence leaving a slab 1 ⅝ inches thick ×13 inches wide ×12 foot long. The slab is planed to 1 ½ inches thick ×26 inches wide ×12 foot long. The thickness of the slab may vary depending upon the cut increments during ripping of the boards. Prior to book matching of the sticks.

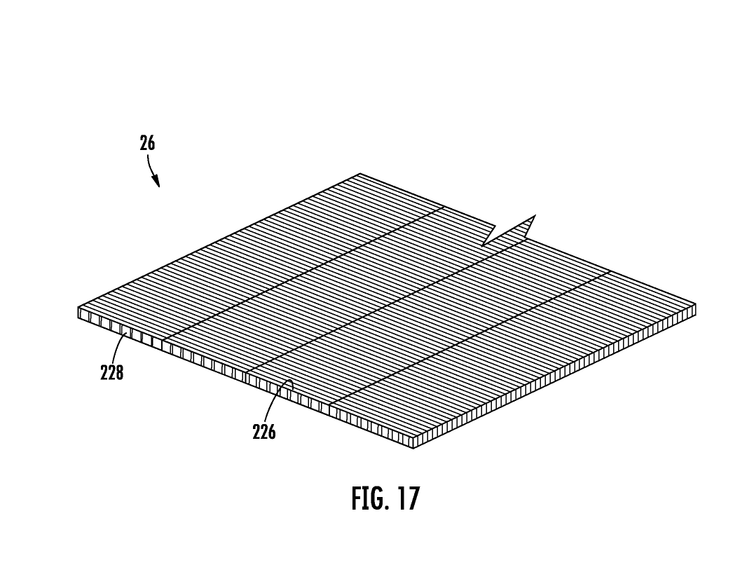

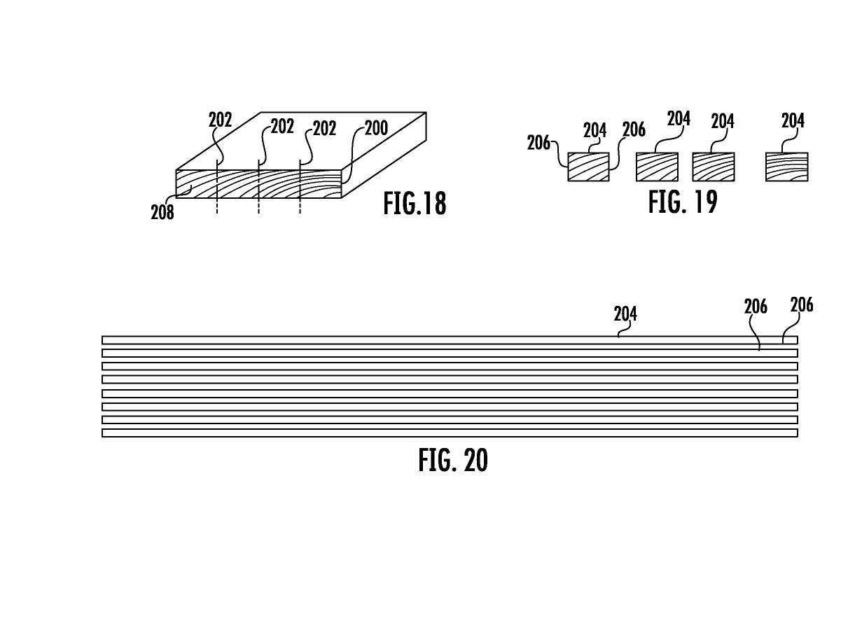

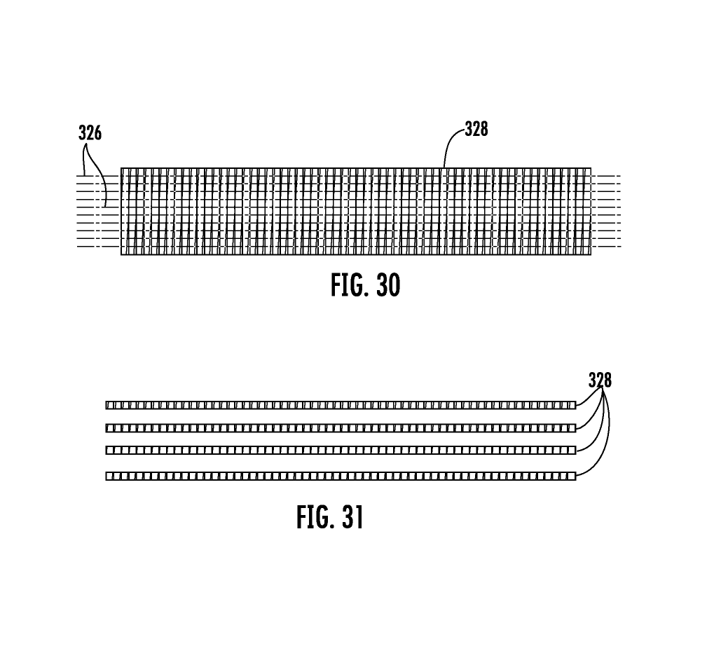

FIG. 18-37 illustrate an alternative series of steps for carrying out method 100 for forming wood end grain slab 26, wherein wood end grain slab 26 shown in FIG. 3 is reoriented 90 degrees in a front to back arrangement . As shown by FIGS. 18-38, wood end grain slab 26 may be formed in accordance with an alternative series of steps, wherein the forming of blocks having sides exposing end grain from oblique cut strips (as set forth in block 112 in FIG. 4) is carried out in a slightly different manner. As indicated by step 102 in FIG. 4 and illustrated in FIGS. 18 and 19, method 100 starts by ripping a board 200 along cut lines 202 extending parallel to the longitudinal lengthwise edges of board 200 so as to form a plurality of ordered parallel cut strips 204 having lengthwise edges 206. As shown by 18 and 19, board 200 and each of strips 204 has an end grain 208.

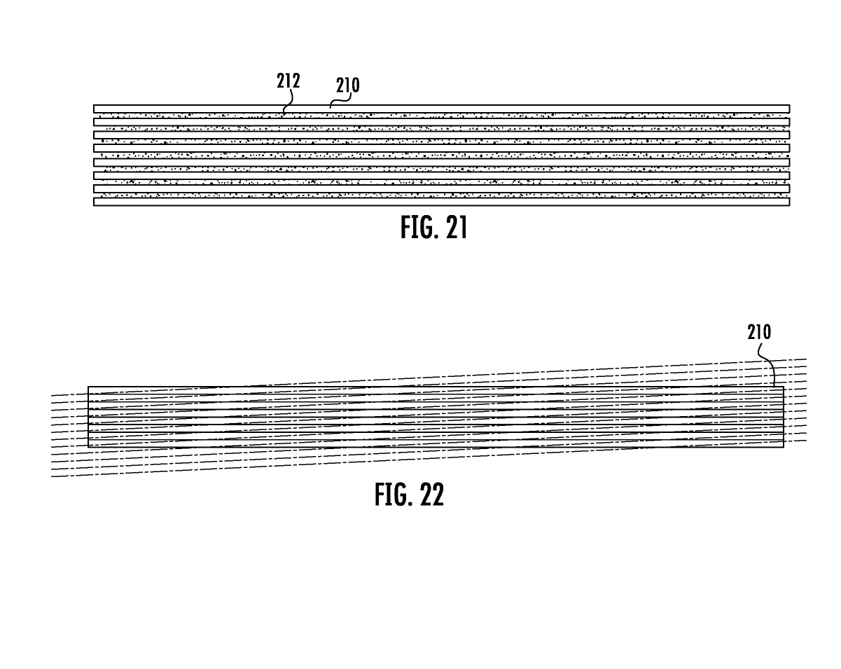

As indicated by step 106 and illustrated by FIGS. 20 and 212, the parallel cut strips 204 are glued, in order, together along lengthwise edges 206, wherein glue is placed along surfaces of edges 206, to form glued board 210 (shown completed in FIG. 21). Board 210 is similar to board 200.

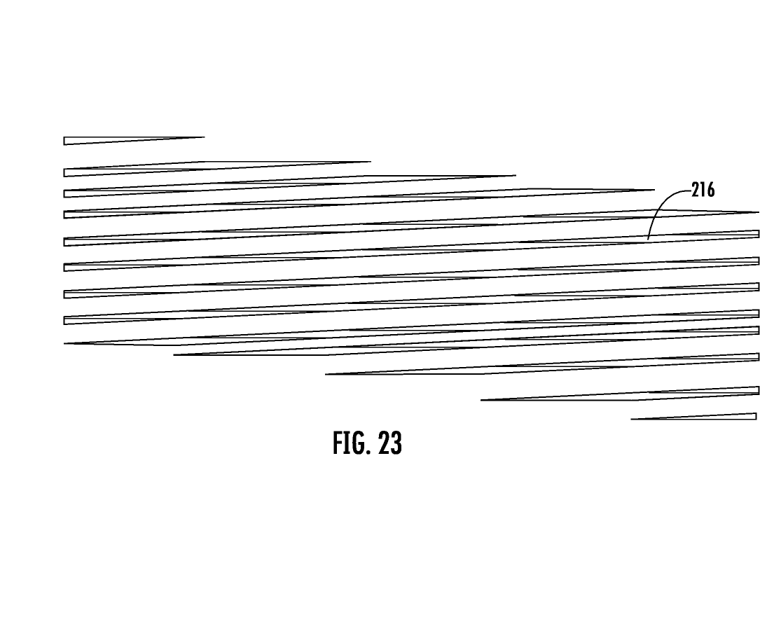

As indicated by step 108 and illustrated by FIGS. 22 and 23, method 100 comprises ripping the glued board 210 (shown in FIG. 21) at an angle oblique to the lengthwise edges 206 of the strips 204 to form oblique cut strips 216. In one implementation, the oblique angle at which glued board 210 is cut is less than or equal to 5 degrees. In one implementation, each of the oblique cut strips 216 have a width of less than 2.5 inches. As noted above with respect to the completed slab 226, the construction of the finished slab 216 allows slab 216 to have a reduced thickness without the normally associated problems of cracking, shrinkage and warping. Cutting strips 216 with a width of less than 2.5 inches ultimately facilitates the formation of slab 326 with a thickness of less than 2.5 inches.

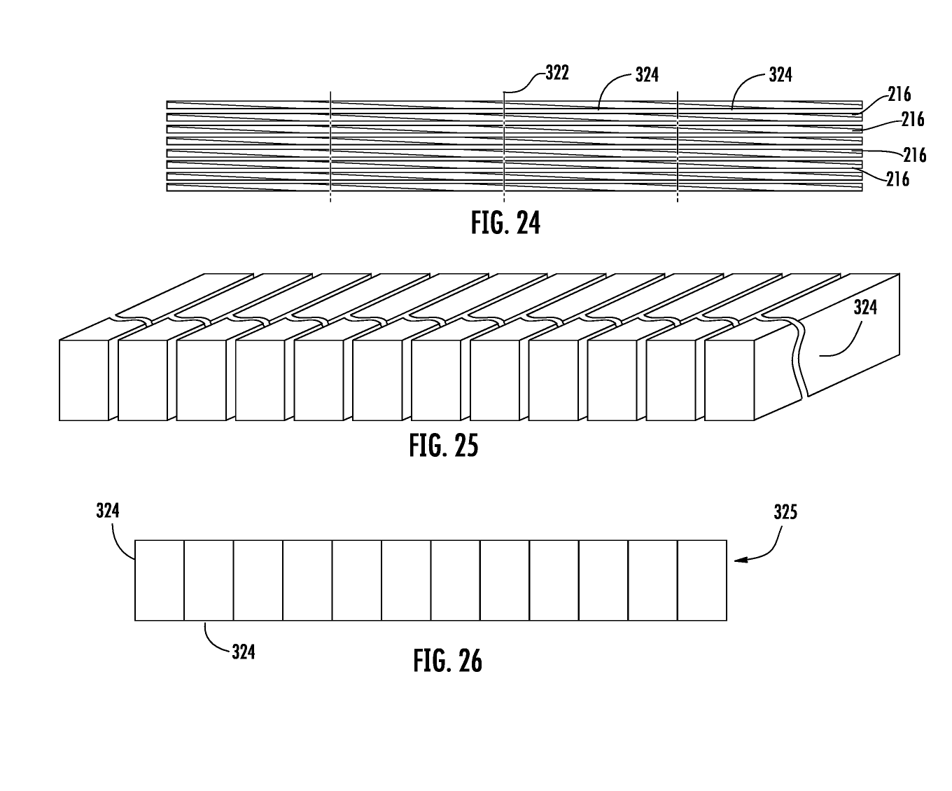

As indicated by step 112 (shown in FIG. 4), the oblique cut strips 216 formed in step 108 are formed into blocks 328 having sides exposing end grain. FIGS. 24-31 illustrate one example series of steps for forming the oblique cut strips 216 into blocks having sides exposing end grain. As shown by FIG. 24, the oblique cut strips 216 are crosscut along cut lines 322 into segments 324 of equal predetermined lengths. Due to the oblique angle at which plank 210 is cut, the cutting of plank 210 forms complete segments having a predefined length and partial segments having lengths less than the predefined length. In one implementation, the partial segments are glued and-two-and to form glued segments having the predefined length. Such glued segments having the predefined length. For example, one implementation, the predefined length is 36 inches. Some partial segments may have a length of 24 inches and 12 inches, wherein such partial segments are glued end-to-end to form a completed glued segment having the predefined length of 36 inches. Some partial segments, when glued together, may have a length greater than the predefined or predetermined length, wherein the excess is removed to form a completed segment having a predefined length.

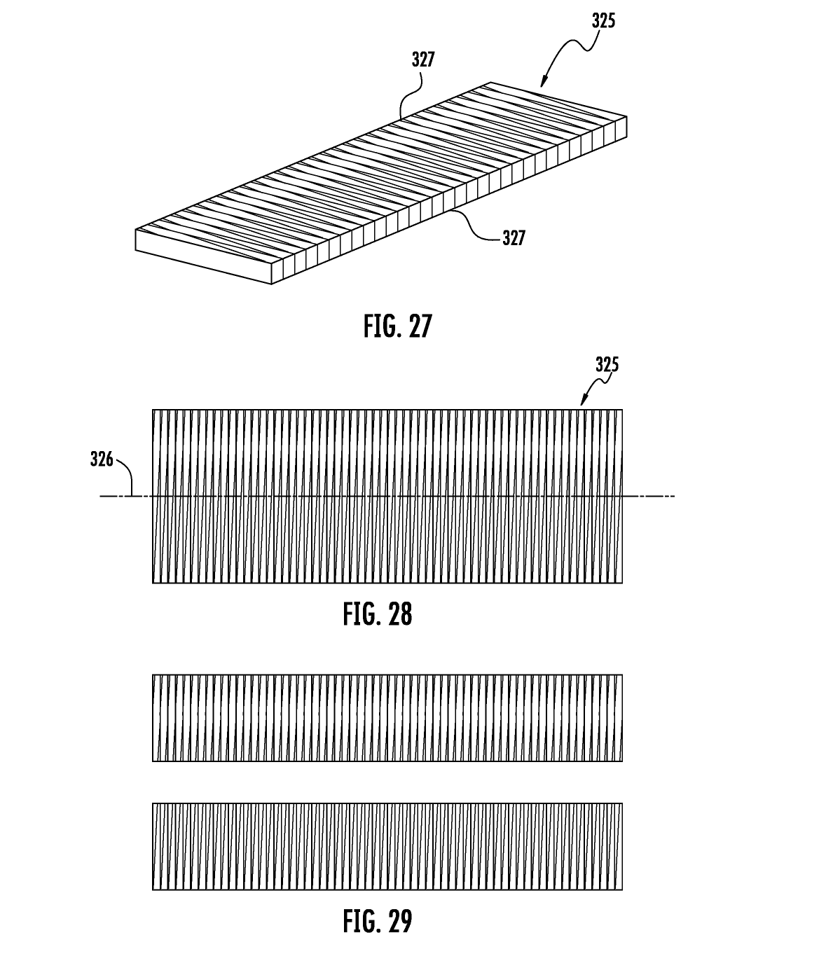

As shown by FIG. 25, segments 324 are reoriented such that the edges 327 formed by cut lines 322 extends alongside one another and such that the opposite faces of segments 324 face one another. It should be noted that edges 327 expose end grain. As noted above, in some implementations, some of segments 324 may comprise partial segments that are glued end-to-end. As shown by FIGS. 26 and 27, segments 324 are glued together side-by-side to form plank 325. As shown by FIGS. 28-31, blocks 328 are then formed by severing plank 325 lengthwise, along multiple cut lines 326 parallel to the side edges 327 of plank 325.

As indicated by step 114 in FIG. 4 and illustrated in FIG. 32, adjacent pairs of blocks 328 are rotated to book match such pairs of blocks 328 such sides 327 of adjacent block 328, exposing end grain, face either an upper down direction and such that the end grain previously expose along the sides 327 of the blocks 328 mirror one another, wherein the end grain 208 of one block of a pair mirrors the end grain 208 of the associated other block of the pair. In one implementation, such book match rotation involves rotating one block 328 of the pair clockwise and the other block 328 of the pair counterclockwise, either away from one another or towards one another.

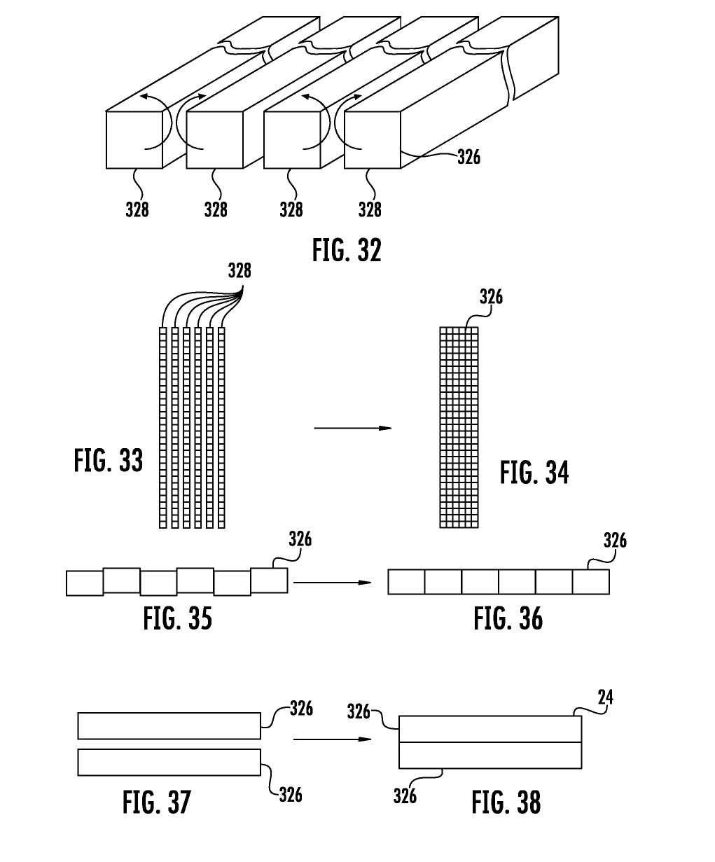

As indicated by step 116 in FIG. 4 and illustrated in FIGS. 33 and 34, the book matched blocks 328 shown in FIG. 31 are kept in order and glued to one another along faces 328 to form the wood end grain slab 326 shown in FIG. 38. As shown by FIGS. 35 and 36, the formed wood end grain slab 326 is further planed to a predetermined uniform thickness across its dimension. As shown in FIGS. 37 and 38, slab 326 is glued to one or more other slabs 326 to form top 24 for counter 20 (shown in FIG. 1) or for other uses.

According to one implementation, 5/4 select lumber is ripped to 1 ⅝ inch widths leading faces 1 inch thick (roughly) ×1 ⅝ inches wide ×12 foot long. The ripped takes are glued together to form boards 1 inch thick ×13 inches wide by 12 foot long. The glued boards are ripped near the centerline at a slight angle (less than 5°) and then remaining have the ripped parallel to slight angle in 1 ⅝ inch increments leading sticks 1 inch thick ×1 ⅝ inches wide ×variable lengths. The six of them cut to 36 inch lengths leaving 1 inch thick ×1 ⅝ inches wide ×36 inches long. 36 inch long six are stacked with the 1 ⅝ inches dimension set vertical and glued together to a 12 foot length leaving a slab 1 ⅝ inches thick ×36 inches wide ×12 foot long. The slabs are cut in half to create to slabs 1 ⅝ inches thick ×36 inches wide ×12 foot long. The two slabs are planed to 1 ½ inches thickness smooth on both sides and kept in their original order. The slabs are then cut lengthwise in increments of 1 ⅝ inches leading sticks 1 ½ inches thick ×1 ⅝ inches wide ×12 foot long. The sticks are kept in their original order in sequence. The stakes are then rotated in pairs towards each other and up as if opening a book. The result is the exposure of an grain, book matched pairs come in sequence. The six and a stack in that order include lengthwise to form slabs 1 ⅝ inches thick ×14 inches wide ×12 foot long. The slabs or planes to 1 ½ inches thick. The slabs are glued together in the original order to form a slab 1 ½ inches thick ×26 inches wide ×12 foot long.

In one implementation, board 200 from which strips 204 cut comprises 5/4 select lumber that is ripped into strips 204 individually having widths of 1 ⅝ inches, thicknesses of roughly 1 inch and lengths of 12 feet. The plank of FIG. 8 has a thickness of 1 inch, a width of 13 inches and a length of 12 feet. The oblique cut strips of FIG. 10 each have a thickness of 1 inch, a width of 1 ⅝ of an inch and variable lengths. The segments of FIG. 25 each have a thickness of 1 inch, a width of 1 ⅝ inches and a length of 36 inches. The planed slab shown in FIG. 36 has a thickness of 1 ½ inches. The glued together slab shown in FIG. 38 has a thickness of 1 ½ inches a width of 26 inches and a length of 12 feet. In other implementations, board 200, strips 216, segments 224 and the resulting glued together slab may have other dimensions. Overall, method 100 facilitates commercially viable production of slabs 26, 326 with consistent patterning having continuously varying block lengths and grain book matching to reduce cracking, shrinkage and warping.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. A method comprising:
ripping a board lengthwise into a plurality of ordered parallel cut strips having lengthwise edges;
gluing the parallel cut strips, in order, together along the lengthwise edges to form a glued board;
ripping the glued board at an angle oblique to the lengthwise edges to form oblique cut strips;
forming blocks having sides exposing end grain from the oblique cut strips;
rotating adjacent blocks to book match the adjacent blocks such that the end grain of the adjacent blocks mirror one another; and
gluing the book matched strips to form a wood end grade slab.

2. The method of claim 1, wherein forming the blocks comprises:
gluing the oblique cut strips to form and oblique glued board; and
crosscutting the oblique glued board widthwise into the blocks.

3. The method of claim 1, were informing the blocks comprises:
crosscutting the oblique cut strips widthwise into segments;
gluing the segments side-by-side to form a plank; and
severing the plank lengthwise into the blocks.

4. The method of claim 3, wherein crosscutting the oblique cut strips widthwise into segments forms complete segments having a predefined length and partial segments having lengths less than the predefined length and wherein the method further comprises:
gluing the partial segments end-to-end to form glued segments having the predefined length;
gluing the glued segments and the complete segments side-by-side to form the plank.

5. The method of claim 1, wherein the angle oblique to the lengthwise edges is less than or equal to 5 degrees.

6. The method of claim 1, wherein the oblique cut strips have a width of less than 2.5 inches.

7. A wood end grain slab comprising:
a plurality of wooden blocks of varying length adhered side-by-side with adjacent pairs of the blocks having an upper surface with end grain patterns that mirror one another.

8. The wood end grain slab of claim 7, wherein the slab comprises adhered rows of the wooden blocks comprising:
a first row of blocks, the first row blocks comprising a first adjacent pair of blocks having the upper surface with the end grain patterns that mirror one another, the blocks of the first adjacent pair having a first length along the first row;
a second row of blocks, the second row blocks comprising a second adjacent pair of blocks having the upper surface with the end grain patterns that mirror one another, the blocks of the second adjacent pair having a second length along the second row different than the first length; and
a third row blocks between the first row blocks and the second row blocks adjacent to the first row blocks in the second row blocks, the third row blocks comprising a third adjacent pair of blocks having the upper surface with the end grain patterns that mirror one another, the blocks of the third adjacent pair having a third length along the third row different than the first length and the second length.

9. The wood grain end slab of claim 7 further comprising a fourth row of blocks adjacent the third row of blocks, the fourth row blocks comprising a fourth adjacent pair of blocks having the upper surface with the end grain patterns that mirror one another, the blocks of the fourth adjacent pair having a fourth length along the fourth row different than the first length, the second length and the third length.

10. The wood grain end slab of claim 7, wherein the slab comprises adhered rows of the wooden blocks, wherein each of the adhered rows comprises a series of the blocks adhered to one another end to end along glue lines, wherein the glue lines of each of at least three consecutive adhered rows are misaligned with respect to the other two of the at least three consecutive adhered rows.

11. The wood grain end slab of claim 7, wherein the slab has a thickness of less than 2.5 inches.

12. A counter comprising:
a base;
a top supported by the base, the top comprising:
a plurality of wooden blocks of varying length adhered side-by-side with adjacent pairs of the blocks having an upper surface with end grain patterns that mirror one another.
